(19) United States
(12) Patent Application Publication
(10) Pub. No.: US 2019/0258367 A1
(43) Pub. Date: Aug. 22, 2019

(54) APPLIANCE FEATURE INTERACTIVE DEMONSTRATION METHOD

(71) Applicant: Haier US Appliance Solutions, Inc., Wilmington, DE (US)

(72) Inventor: Steven Keith Root, Buckner, KY (US)

(21) Appl. No.: 15/900,929

(22) Filed: Feb. 21, 2018

(51) Int. Cl. G06F 3/0484; G06F 3/0482; G06F 3/0488; H04R 1/02; H04R 3/00

(52) U.S. Cl. CPC G06F 3/0484; G06F 3/0482; H04R 3/00; H04R 1/028; G06F 3/04883

(57) ABSTRACT

A method for interactive demonstration of an appliance feature includes displaying an appliance feature vignette from a remote server on a computing device in response to a user request at the computing device, and operating a plurality of user prompts on an appliance during the appliance feature vignette. The computing device is connected to a remote server via a network.

### FIELD OF THE INVENTION

The present subject matter relates generally to methods for interactive demonstration of appliance features.

### BACKGROUND OF THE INVENTION

Appliances are increasingly complex and include numerous features not available on earlier appliances. Demonstration and training are useful to teach an appliance user how to utilize new features. However, demonstration and training materials can be expensive to produce, and each appliance model can require unique demonstration and training materials. Accordingly, demonstration and training materials generally do not scale well across appliance families with multiple models.

Current demonstration and training materials are frequently printed instruction sheets that do not have a high level of user interaction. The instructions can be difficult to follow resulting in a poor user experience. In addition, due to prohibitive costs, only a single set of demonstration and training materials may be generated for every model within an appliance family. Due to differences between the various models, the single set of demonstration and training materials frequently does not translate well to physical interactions with certain appliance models within the family. For example, appliance overlays may be different in such appliance models compared to the demonstration and training materials. Known appliances are equipped with a demonstration mode. However, such demonstration modes simply allow an appliance user to engage with the user interface and lack any clarifying feedback or instructions.

### BRIEF DESCRIPTION OF THE INVENTION

The present subject matter provides a method for interactive demonstration of an appliance feature. The method includes displaying an appliance feature vignette from a remote server on a computing device in response to a user request at the computing device, and operating a plurality of user prompts on an appliance during the appliance feature vignette. The computing device is connected to a remote server via a network. Additional aspects and advantages of the invention will be set forth in part in the following description, or may be apparent from the description, or may be learned through practice of the invention.

In a first example embodiment, a method for interactive demonstration of an appliance feature includes connecting an appliance and a computing device to a remote server via a network. The computing device is positioned proximate the appliance. The method also includes displaying an appliance feature vignette from the remote server on the computing device in response to a user request at the computing device. The appliance feature vignette includes a plurality of instruction steps for activating the appliance feature. The method further includes operating a plurality of user prompts on the appliance during the appliance feature vignette in response to a plurality of user prompt commands from the remote server. Each user prompt of the plurality of user prompts corresponds to a respective one of the plurality of instruction steps.

In a second example embodiment, a method for interactive demonstration of an appliance feature includes connecting an appliance and a computing device to a remote server via a network. The computing device is positioned proximate the appliance. The method also includes displaying an appliance feature vignette from the remote server on the computing device in response to a user request at the computing device. The appliance feature vignette includes a plurality of interactive step tags. The method further includes operating a plurality of user prompts on the appliance during the appliance feature vignette. Each user prompt of the plurality of user prompts is triggered at a respective one of the plurality of interactive step tags. The appliance feature vignette pauses at each interactive step tag of the plurality of interactive step tags until the respective user prompt of the plurality of user prompts on the appliance is actuated.

In a third example embodiment, a method for interactive demonstration of an appliance feature includes connecting a computing device to a remote server via a network and displaying an appliance feature vignette from the remote server on the computing device in response to a user request at the computing device. The appliance feature vignette includes a plurality of interactive step tags. The method also includes operating a plurality of user prompts on a virtual appliance during the appliance feature vignette. Each user prompt of the plurality of user prompts is triggered at a respective one of the plurality of interactive step tags. The appliance feature vignette pauses at each interactive step tag of the plurality of interactive step tags until the respective user prompt of the plurality of user prompts on the virtual appliance is actuated.

In a fourth example embodiment, a method for interactive demonstration of an appliance feature includes displaying an appliance feature vignette on the computing device in response to a user request at the computing device. The appliance feature vignette includes a plurality of interactive step tags. The method also includes operating a plurality of user prompts on an appliance during the appliance feature vignette. Each user prompt of the plurality of user prompts is triggered at a respective one of the plurality of interactive step tags. The appliance feature vignette pauses at each interactive step tag of the plurality of interactive step tags until the respective user prompt of the plurality of user prompts on the appliance is actuated.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a schematic view of a network connected appliance according to an example embodiment of the present subject matter.

FIG. 2 illustrates a method for interactive demonstration of an appliance feature according to an example embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

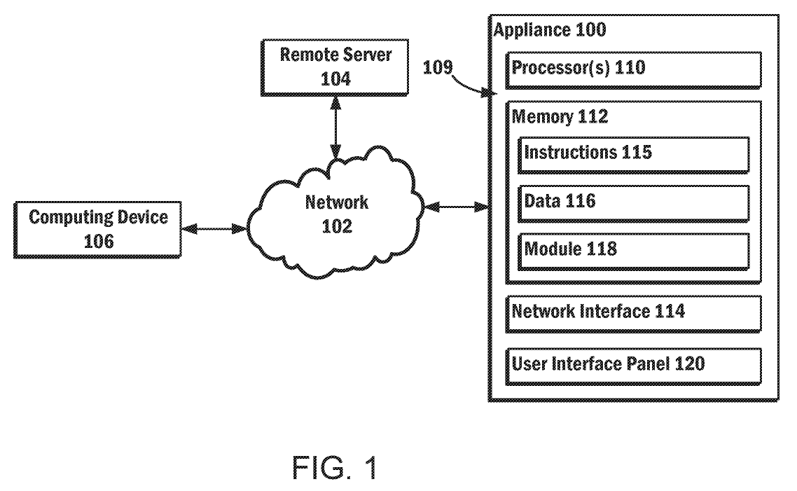

FIG. 1 is a schematic view of a network connected appliance 100 according to an example aspect of the present subject matter. Appliance 100 is connectable to a network 102. Thus, e.g., appliance 100 may communicate with a remote server 104 via network 102. In particular, appliance 100 may transmit data, e.g., related to operation of appliance 100, from appliance 100 to remote server 104 via network 102. As discussed in greater detail below, appliance 100 includes features for interactive demonstration of an appliance feature. Thus, appliance 100 may more efficiently and effectively train a user of appliance 100 to utilize the appliance feature compared to known appliances.

Appliance 100 includes one or more processors 110, a memory 112, and a network interface 114. As used herein, an appliance can be any machine or device for performing a specific task that also includes features for connecting to a network, including, without limitation, a clothes dryer, a clothes washer, a dishwasher, a refrigerator, a stove, an oven, a microwave, a cooktop, a range hood, a window AC unit, an HVAC system controller, a water heater, etc. Network interface 114 of appliance 100 can include any suitable components for interfacing with one more networks, such as network 102. For example, network interface 114 of appliance 100 may include transmitters, receivers, ports, controllers, antennas, or other suitable components.

Network interface 114 may establish communication with network 102 via a connection through any suitable medium, e.g., wired or wireless. Network 102 may be any type of communications network, such as a local area network (e.g. intranet), wide area network (e.g. Internet), or some combination thereof. In general, communication between controller 109 and network 102 may be carried via associated network interfaces using any type of connection, using a variety of communication protocols (e.g. TCP/IP, HTTP), encodings or formats (e.g. HTML, XML), and/or protection schemes (e.g. VPN, secure HTTP, SSL). In particular, the network 102 may be a wireless local area network (WLAN) configured to conform to IEEE 802.11.

The processor(s) 110 of appliance 100 can be any suitable processing device, such as a microprocessor, microcontroller, integrated circuit, or other suitable processing device. The memory 112 of appliance 100 can include any suitable computing system or media, including, but not limited to, non-transitory computer-readable media, RAM, ROM, hard drives, flash drives, or other memory devices. The memory 112 of appliance 100 can store information accessible by processor(s) 110 of appliance 100, including instructions 115 that can be executed by processor(s) 110 to control various components of appliance 100 to provide appliance functionality and data 116. Thus, the combination of one or more processors 110 and memory 112 may correspond to a controller configured to implement various programs or methods to operate appliance 100, and processors 110 and memory 112 may be collectively referred to herein as a controller 109. Input/output (“I/O”) signals may be routed between controller 109 and various operational components of appliance 100 along wiring harnesses that may be routed within appliance 100.

A module 118 is included or stored in memory 112 of appliance 100. It will be appreciated that the term “module” refers to computer logic utilized to provide desired functionality. Thus, a module can be implemented in hardware, application specific circuits, firmware and/or software controlling a general purpose processor. In one embodiment, modules are program code files stored on the storage device, loaded into memory and executed by a processor or can be provided from computer program products, for example computer executable instructions, that are stored in a tangible computer-readable storage medium such as RAM, hard disk or optical or magnetic media. Thus, while module 118 is shown stored in memory 112 of appliance 100 in the example embodiment shown in FIG. 1, module 118 may be stored in or implemented by any other suitable component of system 100 in alternative example embodiments.

Appliance 100 also includes a user interface panel 120. User interface panel 120 is located within convenient reach of a user of appliance 100. User interface panel 120 includes various input components, such as one or more of a variety of touch-type controls, electrical, mechanical or electro-mechanical input devices including knobs, rotary dials, push buttons, and touch pads. The user interface panel 120 may include a display component, such as a digital or analog display device, designed to provide operational feedback to a user.

Various appliance features of appliance 100 may be activated/deactivated by a user manipulating the input components on user interface panel 120. Thus, e.g., when appliance 100 is a cooktop or oven appliance, a user may manipulate knobs or buttons on user interface panel 120 to activate and deactivate heating elements of the appliance. As another example, when appliance 100 is a refrigerator appliance, a user may manipulate buttons on user interface panel 120 to adjust the sealed system set temperature of the appliance. As yet another example, when appliance 100 is a washing machine or dryer appliance, a user may manipulate knobs or buttons on user interface panel 120 to start treatment of clothing items within the appliance.

As may be seen in FIG. 1, a computing device 106 is connectable to a network 102. Thus, e.g., computing device 106 may communicate with appliance 100 and/or remote server 104 via network 102. As an example, computing device 106 may transmit user command inputs to appliance 100 and/or remote server 104 via network 102. Thus, computing device 106 may include suitable input components, such as touch-type controls, electrical, mechanical or electro-mechanical input devices, etc. As another example, computing device 106 may receive video, audio and/or text data from remote server 104 via network 102 and display such data to a user of computing device 106. Thus, computing device 106 may include a suitable display, such as a digital or analog display. As may be seen from the above, computing device 106 is network connected and includes user inputs and a display. Thus, e.g., computing device 106 may be a smartphone, tablet, network connected television, etc. that allows display of data from network 102 and transmission of user inputs over network 102.

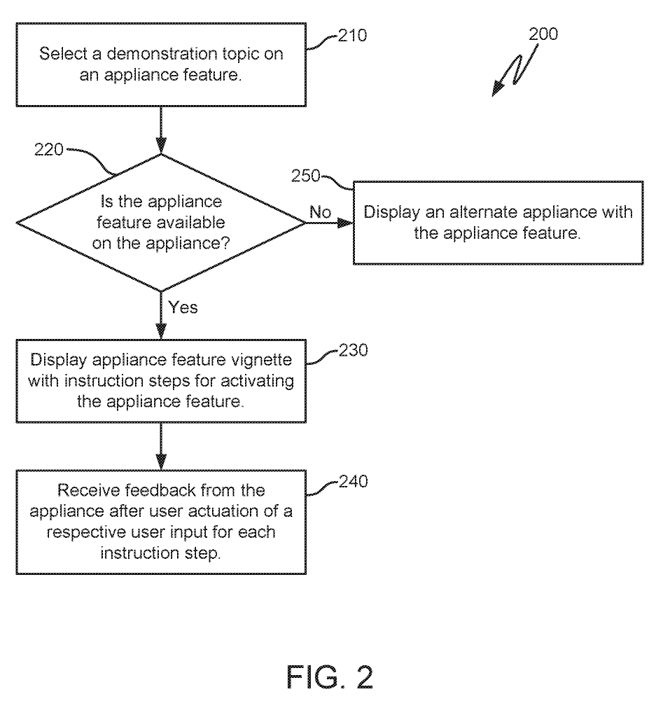

An example method for interactive demonstration of an appliance feature of appliance 100 will now be described. FIG. 2 illustrates a method 200 for interactive demonstration of an appliance feature according to an example embodiment of the present subject matter. Method 200 may more efficiently and effectively train a user of appliance 100 to utilize the appliance feature relative to known appliances. It will be understood that while discussed below in a certain sequence, method 200 may be performed in other suitable sequences in alternative example embodiments. Thus, method 200 is not limited to the particular sequence described below.

Initially, appliance 100 and computing device 106 may be connected to remote server 104 via network 102. Thus, appliance 100, remote server 104 and computing device 106 may communicate with one another via network 102 in method 200. It will be understood that the communication between appliance 100, remote server 104 and computing device 106 over network 102 may be arranged with a peer-to-peer architecture and/or a client-server architecture.

Computing device 106 may be positioned proximate appliance 100 in method 200. Thus, e.g., a user of computing device 106 may also correspond to a user of appliance 100 in method 200. For example, as noted above, computing device 106 may be a smartphone, a tablet, a network connected television, etc., and the user of appliance 100 may utilize computing device 106 to view demonstration and instruction material on computing device 106 while also interfacing with appliance 100.

At 210, method 200 includes selecting a demonstration topic on an appliance feature of appliance 100. In particular, the user of appliance 100 may select the demonstration topic from a list of demonstration topics on computing device 106. As example, when appliance 100 is an oven appliance, the user of oven appliance 100 may select “convection baking” from a list on computing device 106 in order to learn about convection baking with the appliance. Alternatively, the list of topics when appliance 100 is an oven appliance may include “self-cleaning,” “Sabbath mode,” “remote control,” etc. Other suitable topics may be provided appliance 100 is another type of appliance 100. Thus, it will be understood that the present subject matter is not limited to a particular demonstration topic and that the demonstration topics listed above are provided by way of example only. Suitable demonstration topics may be provided for each type of appliance in order to demonstrate appliance features of each appliance.

At 220, it is determined whether the appliance feature is available on appliance 100. For example, appliance 100 may be queried by remote server 104 to determine whether the appliance feature is supported by appliance 100 in response to a user request for the demonstration topic at computing device 106. In particular, appliance 100 may communicate a model number of appliance 100 to remote server 104 after such query, and remote server 104 may compare the model number to a list of appliance models with the appliance feature in order to determine whether the appliance feature is supported by appliance 100. At 230, an appliance feature vignette is displayed on computing device 106 when the appliance feature is supported by appliance 100. Alternatively, at 250, a list of one or more alternative appliances with the appliance feature may be displayed on computing device 106 when the appliance feature is not supported by appliance 100.

As noted above, an appliance feature vignette is displayed on computing device 106 at 230. In particular, the appliance feature vignette may be transmitted from the remote server 104 and displayed on computing device 106 in response to the user request at computing device 106 from 210. The appliance feature vignette includes a plurality of instruction steps for activating the appliance feature. Thus, e.g., the user of appliance 100 may view instruction steps for activating the appliance feature within the appliance feature vignette on computing device 106. In such a manner, the user of appliance 100 may be educated about the appliance feature during method 200. As an example, the appliance feature vignette may include audio, video, and/or text that explains the appliance feature and/or how to activate the appliance feature.

The appliance feature vignette on computing device 106 may also be configured to provide or utilize feedback from appliance 100 to monitor user interaction with appliance 100 during the appliance feature vignette. In particular, at 240, method 200 includes operating a plurality of user prompts on appliance 100 during the appliance feature vignette. Each user prompt corresponds to a respective one of the instruction steps in appliance feature vignette. Thus, e.g., each user prompt on appliance 100 may be activated when the respective one of the instruction steps in appliance feature vignette is playing on computing device 106. In such a manner, appliance 100 may provide additional information to the user of appliance 100 regarding the appliance feature during the appliance feature vignette. In certain example embodiments, the user prompts on appliance 100 may be activated in response to a plurality of user prompt commands from remote server 104. Thus, the user prompts on appliance 100 may synchronized with the instruction steps in appliance feature vignette on computing device 106 through remote server 104.

As a particular example, the appliance feature vignette may include a plurality of interactive step tags. Each user prompt may be triggered at a respective one of the interactive step tags. Thus, while the appliance feature vignette is displayed on computing device 106, each of the user prompts on appliance 100 may activate at the respective one of the interactive step tags in the appliance feature vignette. In particular, when the appliance feature vignette is a video, the appliance feature vignette may show each input component on user interface panel 120 that must be actuated to activate the appliance feature. To make the appliance feature vignette more effective, the user prompts on appliance 100 encourage the user to engage with appliance 100 during the appliance feature vignette. Thus, the user of appliance 100 may fully experience engaging the appliance feature during the appliance feature vignette with the assistance of the user prompts on appliance 100.

To facilitate engagement with the appliance 100, the appliance feature vignette may be paused on computing device 106 at each instruction step or interactive step tag until the respective user prompt on appliance 100 is actuated. Thus, to continue the appliance feature vignette, the user of appliance 100 engages with appliance 100 in the appropriate manner to activate the appliance feature. For example, the appliance feature vignette may be paused until the user of appliance actuates one particular input on user interface panel 120 that is required to activate the appliance feature. After actuating the one particular input on user interface panel 120, the appliance feature vignette continues and displays the next step required to activate the appliance feature. Appliance 100 may communicate with computing device 106 via network 102 to determine when to activate the user prompts on appliance 100 and when to continue the appliance feature vignette after actuation of the user prompt on appliance 100.

The user prompts on appliance 100 encourage and/or require the user to engage with appliance 100 during the appliance feature vignette. Thus, the user prompts may draw the user's attention from the appliance feature vignette on computing device 106 to appliance 100. The user prompts on appliance 100 may be an audio or visual cue to the user of appliance 100. For example, the user prompts may include activating a light behind one particular input on user interface panel 120. Thus, the user's attention may be drawn to the one particular input on user interface panel 120, and the user may actuate the one particular input on user interface panel 120. As another example, the user prompts may include a display prompt on a touch panel of user interface panel 120. Thus, the user's attention may be drawn to the touch panel on user interface panel 120, and the user may engage the touch panel on user interface panel 120. As yet another example, the user prompts may include an audio tone played from a speaker of appliance 100. Thus, the user's attention may be drawn towards appliance 100, and the user may engage appliance 100.

Method 200 may assist with training a user of appliance 100 to utilize an appliance feature. During method 200, the user may actuate the appropriate inputs on user interface panel 120 to activate the appliance feature, and the user prompts on appliance 100 may ensure user interaction with appliance 100 during the training. However, controller 109 may be configured to not actually implement the appliance feature during method 200. Thus, e.g., appliance 100 may not implement or activate the appliance feature during method 200. In particular, appliance 100 may be deactivated during the appliance feature vignette except for network interface 114, user interface panel 120, and other components of appliance 100 needed for method 200.

In the above described example embodiments, appliance 100 is a physical appliance 100, e.g., installed at a residence, business, etc. However, in alternative example embodiments, appliance 100 may be a virtual appliance. In particular, appliance 100 may be a virtual appliance displayed on computing device 106 during method 200. Thus, appliance 100 may be represented virtually on computing device 106 to allow the user of computing device 106 to engage with appliance 100 virtually during the appliance feature vignette.

Utilizing method 200, training and demonstration of appliance features on appliance 100 may be more general and easier to produce relative to known methods. Accordingly, the user of appliance 100 may be presented with a fuller and/or more accurate user experience during demonstration and training for appliance 100.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for interactive demonstration of an appliance feature, comprising:
connecting an appliance and a computing device to a remote server via a network, the computing device positioned proximate the appliance;
displaying an appliance feature vignette from the remote server on the computing device in response to a user request at the computing device, the appliance feature vignette including a plurality of instruction steps for activating the appliance feature; and
operating a plurality of user prompts on the appliance during the appliance feature vignette in response to a plurality of user prompt commands from the remote server, each user prompt of the plurality of user prompts corresponding to a respective one of the plurality of instruction steps.

2. The method of claim 1, wherein the appliance feature vignette pauses at each instruction step of the plurality of instruction steps until the respective user prompt of the plurality of user prompts on the appliance is actuated.

3. The method of claim 1, further comprising:
prior to displaying the appliance feature vignette, querying the appliance to determine whether the appliance feature is supported by the appliance in response to the user request at the computing device; and
displaying the appliance feature vignette when the appliance feature is supported by the appliance.

4. The method of claim 3, further comprising displaying a list of one or more alternative appliances with the appliance feature when the appliance feature is not supported by the appliance.

5. The method of claim 1, wherein each user prompt of the plurality of user prompts comprises one or more of a lighted user input on a user interface panel of the appliance, a display prompt on a touch panel of the user interface panel, and a played tone from a speaker of the appliance.

6. The method of claim 1, wherein the appliance feature is not activated during the appliance feature vignette.

7. The method of claim 1, wherein the appliance is an oven appliance, a refrigerator appliance, an air conditioner appliance, a microwave appliance, a water heater appliance, a dishwasher appliance, a washing machine appliance, or a dryer appliance.

8. The method of claim 1, wherein the computing device is a tablet, a smartphone, or a network connected television.

9. A method for interactive demonstration of an appliance feature, comprising:
connecting an appliance and a computing device to a remote server via a network, the computing device positioned proximate the appliance;
displaying an appliance feature vignette from the remote server on the computing device in response to a user request at the computing device, the appliance feature vignette including a plurality of interactive step tags; and
operating a plurality of user prompts on the appliance during the appliance feature vignette, each user prompt of the plurality of user prompts triggered at a respective one of the plurality of interactive step tags,
wherein the appliance feature vignette pauses at each interactive step tag of the plurality of interactive step tags until the respective user prompt of the plurality of user prompts on the appliance is actuated.

10. The method of claim 9, further comprising:
prior to displaying the appliance feature vignette, querying the appliance to determine whether the appliance feature is supported by the appliance in response to the user request at the computing device; and
displaying the appliance feature vignette when the appliance feature is supported by the appliance.

11. The method of claim 10, further comprising displaying a list of one or more alternative appliances with the appliance feature when the appliance feature is not supported by the appliance.

12. The method of claim 9, wherein each user prompt of the plurality of user prompts comprises one or more of a lighted user input on a user interface panel of the appliance, a display prompt on a touch panel of the user interface panel, and a played tone from a speaker of the appliance.

13. The method of claim 9, wherein the appliance feature is not activated during the appliance feature vignette.

14. The method of claim 9, wherein the appliance is an oven appliance, a refrigerator appliance, an air conditioner appliance, a microwave appliance, a water heater appliance, a dishwasher appliance, a washing machine appliance, or a dryer appliance.

15. The method of claim 9, wherein the computing device is a tablet, a smartphone, or a network connected television.

16. A method for interactive demonstration of an appliance feature, comprising:
connecting a computing device to a remote server via a network;
displaying an appliance feature vignette from the remote server on the computing device in response to a user request at the computing device, the appliance feature vignette including a plurality of interactive step tags; and
operating a plurality of user prompts on a virtual appliance during the appliance feature vignette, each user prompt of the plurality of user prompts triggered at a respective one of the plurality of interactive step tags,
wherein the appliance feature vignette pauses at each interactive step tag of the plurality of interactive step tags until the respective user prompt of the plurality of user prompts on the virtual appliance is actuated.

17. The method of claim 16, further comprising displaying a list of one or more alternative appliances with the appliance feature when the appliance feature is not supported by the virtual appliance.

18. The method of claim 16, wherein each user prompt of the plurality of user prompts comprises one or more of a lighted user input on a user interface panel of the virtual appliance and a display prompt on a touch panel of the user interface panel.

19. The method of claim 16, wherein the computing device is a tablet, a smartphone, or a network connected television.

20. A method for interactive demonstration of an appliance feature, comprising:
displaying an appliance feature vignette on the computing device in response to a user request at the computing device, the appliance feature vignette including a plurality of interactive step tags; and
operating a plurality of user prompts on an appliance during the appliance feature vignette, each user prompt of the plurality of user prompts triggered at a respective one of the plurality of interactive step tags,
wherein the appliance feature vignette pauses at each interactive step tag of the plurality of interactive step tags until the respective user prompt of the plurality of user prompts on the appliance is actuated.
